(19) United States
(12) Patent Application Publication
(10) Pub. No.: US 2015/0370469 A1
(43) Pub. Date: Dec. 24, 2015

(54) SELECTION FEATURE FOR ADJUSTING VALUES ON A COMPUTING DEVICE

(71) Applicant: QUALCOMM INCORPORATED, San Diego, CA (US)

(72) Inventors: Esther Leong, Sunnyvale, CA (US); Liron M. Damir, Sunnyvale, CA (US); Itai Vonshak, Sunnyvalle, CA (US); Krishna Rangarajan, Sunnyvale, CA (US); Chadwyck Wirtz, Sunnyvale, CA (US)

(21) Appl. No.: 14/764,812

(22) PCT Filed: Jan. 31, 2013
(86) PCT No.: PCT/US2013/024168

§ 371 Date: Jul. 30, 2015

(51) Int. Cl. G06F 3/0484; G06F 3/0488; G06F 3/0482

(52) U.S. Cl. CPC G06F 3/04847; G06F 3/04842; G06F 3/0482; G06F 3/0488

(57) ABSTRACT

A selection feature to enable a user to adjust a displayed value is provided on a display of a computing device. The selection feature includes a closed track and a selectable button that is moveable along the closed track. A user input is received from one or more sensors of the computing device that detect an object or a finger on a region of the display that provides the selection feature. The selection feature adjusts the displayed value in a first manner in response to the user selecting and moving the selectable button along the closed track, and adjusts the displayed value in a second manner in response to the user selecting a location on the closed track away from the selectable button. The displayed value is adjusted based on the user input.

### BACKGROUND

Typical touch-sensitive computing devices enable users to interact with applications or device functionalities by making contact with a display screen. Depending on what applications are being operated, the manner in which a user can provide touch input can vary.

### BRIEF DESCRIPTION OF THE DRAWINGS

FIG. 1 illustrates an example system for providing and operating a selection feature for a computing device.

FIG. 2 illustrates an example method for providing and operating a selection feature for a computing device.

FIGS. 3A through 3C illustrate example operations of a selection feature for a computing device.

FIG. 4 illustrates an example of a selection feature for a computing device.

FIGS. 5A and 5B illustrate an example of a selection feature for a computing device.

FIGS. 6A through 6D illustrate an example of a selection feature for a computing device.

FIG. 7 illustrates an example of a selection feature for a computing device.

FIG. 8 illustrates an example of a selection feature for a computing device displayed with an application.

FIG. 9 is a block diagram that illustrates a computing device upon which examples described herein may be implemented.

### DETAILED DESCRIPTION

Examples described herein provide for a system and method to provide a selection feature to enable a user to adjust one or more values by providing touch input on the selection feature. In some examples, the selection feature enables the user to adjust a value or make a selection in multiple ways, based on the user input provided on the selection feature.

A selection feature can be provided on a touch-sensitive display of a computing device. The selection feature can include a closed track and a selectable button that is moveable along the closed track. A user of the computing device can provide a user input by making contact (e.g., with a finger or an object, such as a stylus) with a region of the touch-sensitive display that provides the selection feature. The selection feature can adjust a displayed value or number in a first manner in response to the user selecting and moving the selectable button along the closed track, and adjust the displayed value or number in a second manner in response to the user selecting a location on the closed track away from the selectable button.

In other implementations, a computing device can receive a user input from one or more sensors, such as one or more image capturing components, one or more microphones, one or more proximity sensors, one or more depth sensors, one or more pressure sensors, one or more touch sensors, and/or a combination of the described sensors. The one or more sensors can detect a user's finger or object on a region of the display that provides the selection feature. The one or more sensors can, for example, detect the position of the user's finger or object, the movement of the user's finger or object, and the velocity in which the user's finger or object is moving, relative to the selection feature that is displayed on the display. Based on the user input, the selection feature can adjust a displayed value in a first manner in response to the user selecting and moving the selectable button along the closed track, and adjust the displayed value in a second manner in response to the user selecting a location on the closed track away from the selectable button.

In one example, the selection feature can be provided with or as part of an application to enable a user to adjust or change a value or option that is associated with that application. The application can provide a service and/or have a functionality in which one or more values or options are to be selected by the user. In one implementation, the selection feature can be provided as part of a pop-up feature that is displayed concurrently with at least a portion of the application (e.g., the pop-up feature overlays the interface of the application). Once the user finishes adjusting the value, the selection feature can be dismissed (e.g., automatically after a predetermined period of time, or in response to a user input or selection) and/or the pop-up feature containing the selection feature can be removed from the display.

Still further, depending on variations, the closed track of the selection feature can be formed by two concentric circular boundaries. The larger, outer circle can provide the outer boundary of the closed track while the inner circle provides the inner boundary of the closed track. In other variations, the closed track can be in the form of other shapes, such as an oval, an ellipse, a square or rectangle, a pentagon, etc., depending on the application the selection feature is provided for or user preference.

In some examples, the selection feature can adjust a displayed value in a first manner by increasing the value or decreasing the value based on the user selecting and moving the selectable button along the closed track in a clockwise direction or a counter-clockwise direction, respectively. The selection feature can also adjust the displayed value in a second manner by increasing the value when the user selects a location on the closed track that is clockwise from and within a predetermined distance of the selectable button, or decreasing the value when the user selects a location on the closed track that is counter-clockwise from and within the predetermined distance of the selectable button.

Depending on implementation, different selection features can be provided for different applications and functionalities. For example, for a particular application, the selection feature can have restrictions (such as a minimum and/or a maximum value) to limit the user's selections. In another example, the application can use, or include a functionality for a time element, such as a timer, a clock, and/or dates and times, so that the selection feature for that application enables the user to make distinct selections for adjusting the dates or times.

As described herein, “incremental,” “incrementally,” or other similar terms refer to a change occurring in small amounts, such as one-by-one.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of a computing device. A programmatically performed step may or may not be automatic.

One or more examples described herein can be implemented using programmatic modules or components. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. Examples described herein may be implemented, in whole or in part, on computing devices, such as desktop computers, cellular or smart phones, tablet devices, or laptop computers. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines or devices shown with examples herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, tablet devices) are all examples of machines and devices that utilize processors, memory, and instructions stored on computer-readable mediums. Additionally, some examples may be implemented in the form of computer-programs, or a computer usable carrier medium capable of carrying such a program.

System Description

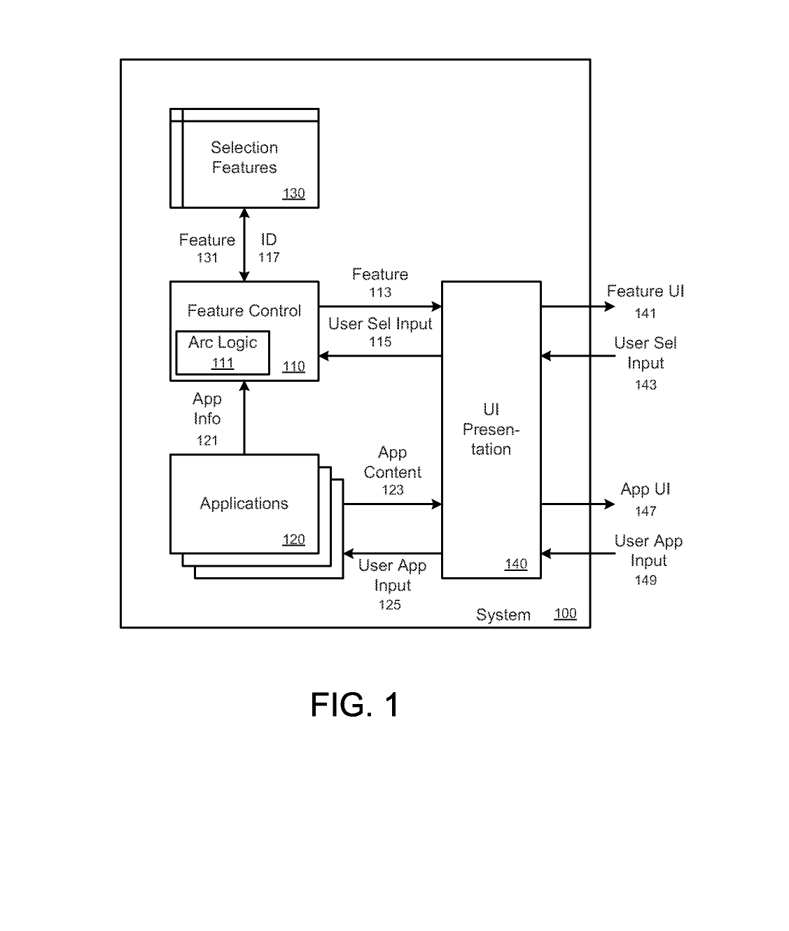

FIG. 1 illustrates an example system for providing and operating a selection feature for a computing device. A system 100, such as described by an example of FIG. 1, can be implemented in a variety of computing environments. For example, some or all of the components of system 100 can be implemented using memory and processing resources of a computing device. System 100 can provide a selection feature to enable a user to interact with the selection feature in order to adjust a displayed value in multiple ways.

According to some examples, system 100 includes a feature control 110, one or more applications 120, selection mechanisms 130, and a presentation component 140. The components of system 100 combine to generate and provide a selection feature on a touch-sensitive display of a computing device, and to receive user input to alter or adjust a value using the selection feature. In some variations, the components that are described in system 100 can be each provided as individual components or modules, or as part of other components. Logic can be implemented with various applications (e.g., software) and/or with hardware of a computing device that implements system 100.

In one example, the feature control 110 can communicate with a selection features database 130, which stores a plurality of different selection features 131 that can be individually displayed on the touch-sensitive display of the computing device. The feature control 110 can also communicate with one or more applications 120 that are stored and/or are currently running on the user's computing device. Based on the application 120 that is being operated, the feature control 110 can select the appropriate selection feature 131 to be displayed with or as part of the application 120.

The applications 120 of the computing device can include applications such as a messaging application, an email application, a contacts application, a calendar application, a documents application, a browser application, a phone application, a camera application, a photo application, a music application, a media application, a game application, a social network application, a banking application, a clock application, a maps application, etc., and other functionalities (e.g., a settings feature, a menu feature, a device manager). One or more of these applications and functionalities 120 can have features or characteristics in which a user can make selections and/or adjust values.

For example, an application can have a feature in which a user is to input a numerical value or integer (e.g., or decimal value). When the user operates this application and requests to input and/or change the numerical value or integer, a selection feature can be provided to enable the user to select the numerical value or integer by manipulating the selection feature. In another example, a clock application can enable a user to change a time element, such as the current time, a timer, or one or more alarms. When the user operates the clock application to adjust a time, a selection feature can be provided to enable the user to set a time (e.g., hour, minutes, seconds) by manipulating the selection feature via touch input on the touch-sensitive display device.

Depending on the application 120 that is being operated by the user on the computing device, the feature control 110 can receive information about the application 121 (e.g., what features or characteristics the application has), and select a corresponding selection feature 131 for the application 120 from the selection features database 130. In some examples, the feature control 110 can use the application information 121 to determine an identifier 117 of a selection feature 131. Using the identifier 117, the feature control 110 can retrieve the appropriate selection feature 131 for that application.

The UI presentation 140 can communicate with the feature control 110 and the one or more applications 120 in order to generate, and provide for display on the touch-sensitive display of the computing device, the selection feature 141 with a corresponding application. The application 120 that is being operated by the user on the computing device can provide the application content or data 123 to the UI presentation 140 so that the UI presentation 140 can generate the user interface (UI) of the application 147. The user can interact with the application 120 by providing a user application input 149 via user contact with the touch-sensitive display. The UI presentation 140 can provide the user application inputs 125 to the application 120 for controlling and operating the application 120.

When the user provides a user application input 149 (e.g., taps on a icon or feature on the touch-sensitive display screen) to adjust a value or make a selection as part of operating the application 120, the UI presentation 140 can provide the selection feature 141 to be displayed on the touch-sensitive display of the computing device. Depending on implementation, the selection feature 141 can be provided in lieu of the operating application 120 (e.g., so that the application UI 147 is not visible), can be provided as part of the application UI 147, or be provided as a pop-up feature that overlaps or overlays a portion of the application UI 147. The UI presentation 140 can provide the appropriate selection feature 141 based on the selection feature information 113 (e.g., the corresponding selection feature of the application 120 that is identified by the feature control 110).

The user of the computing device can manipulate the displayed selection feature 141 to select a number or value. In one example, the selection feature 141 can include a closed track and a selectable button or object (e.g., an icon, a shape) that is moveable along the closed track. The selection feature 141 can also include a displayed value, which can represent the current selection or value. The user can provide a user selection input 143 by making contact (e.g., with the user's finger, hand, stylus, etc.) with a region of the touch-sensitive display that displays the selection feature 141. The user selection input 143 can include (i) the user selecting the moveable object and moving it in one direction or another along the closed track, (ii) the user selecting a location on the closed track that is away from the selectable button, (iii) the user selecting and holding the location on the closed track that is away from the selectable button, or (iv) the user selecting a region that is inside the closed track (or outside the closed track) to change fields if multiple values or options can be adjusted by the user.

In some examples, based on the user selection input 143, the UI presentation 140 can cause the object within the closed track of the selection feature 141 to be moved appropriately. In addition, the user selection input 115, which corresponds to the touch inputs made by the user in manipulating or operating the selection feature 141, can be provided to the feature control 110. The feature control 110 can use the user selection input 115 to adjust the displayed value or number based on the user's input. For example, the feature control 110 can include arc logic 111 to determine how the displayed value is to be changed and by how much, by interpreting the circular movement input (e.g., when the user selects the moveable object and moves it along the closed track) of the user selection input 115 based on one or more rules, conditions, and/or vector calculations. The arc logic 111 can also determine the speed in which the circular movement input is being provided (e.g., which can correspond to how fast the user is moving a finger, object, stylus, etc., along the closed track). The UI presentation 140 can update the displayed value according to the amount indicated (via feature information 113) by the feature control 110.

For example, the feature control 110 can adjust a value or number in a first manner in response to the user selecting and moving the selectable object along the closed track in either direction. In the first manner, the value can be adjusted (e.g., increased or decreased) corresponding to the speed in which the user moves the selectable object along the track. If the user moves the object slowly, the value can be increased or decreased slowly so that the user can see the value changing incrementally. On the other hand, if the user moves the object quickly, the value can be increased or decreased quickly so that the displayed value changes quickly. The feature control 110 can also adjust the displayed value or number in a second manner in response to the user selecting a location on the closed track away from the selectable object. In the second manner, for example, the displayed value can skip subsequent values to jump to another value based on the location on the closed track that the user taps on. In this manner, system 100 enables a user to quickly select values, such as integers, dates, times, etc., by using the selection feature 141.

Methodology

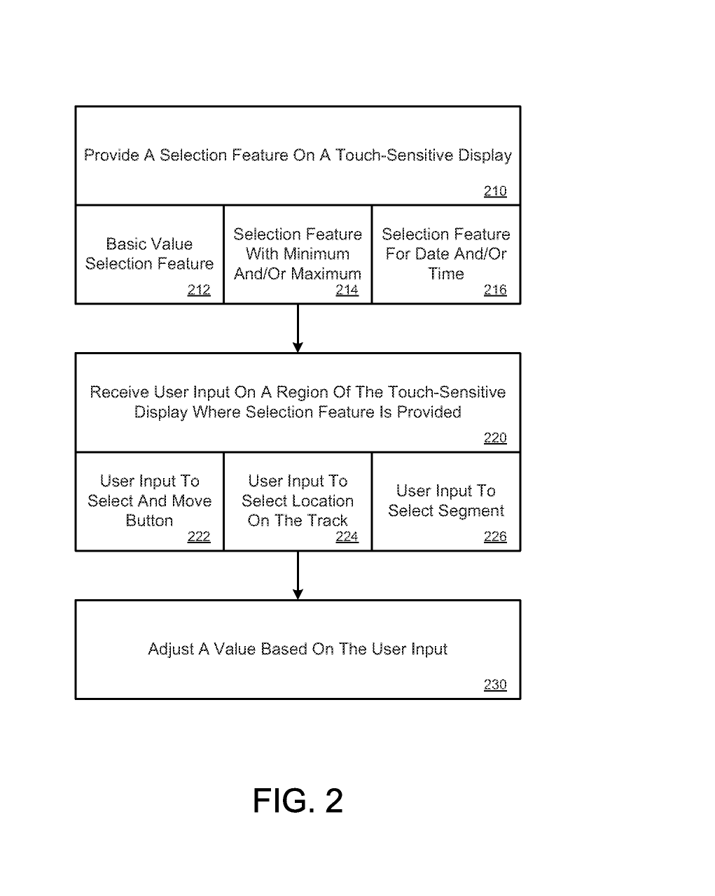

FIG. 2 illustrates an example method for providing and operating a selection feature for a computing device. A method such as described by FIG. 2 can be implemented using, for example, components described with FIG. 1. Accordingly, reference made to elements of FIG. 1 is for purposes of illustrating a suitable element or component for performing a step or sub-step being described.

A selection feature is provided on a touch-sensitive display of a computing device (210). The selection feature can include a closed track and a selectable button or object that is moveable within the track. In some examples, the selection feature can be provided with or as part of an application or device functionality. The selection feature can be displayed in response to a user input to configure, set, or adjust one or more options, values, numbers, times, or dates. The selection feature that is provided can also depend on the application's functionality or characteristics. One example of a selection feature can be a basic selection feature that enables a user to select any number or value (e.g., integers, decimals, positive and/or negative numbers) without an upper limit and/or a lower limit (212). A basic or generic selection feature can enable a user to keep increasing or decreasing the displayed value until the user stops operating the selection feature.

In another example, the selection feature can also be a selection feature having a limit, such as a maximum value and/or a minimum value (214). Such a selection feature can be displayed with or as a part of an application in which a user can input a value in a particular range of values. For example, the user can input a ratings or a score having values between zero and one hundred using an application. The selection feature having a limit can prevent the user from selecting a value that is outside of the limit. The selection feature can also be a selection feature that is specified for adjusting a date and/or a time (216). The date and/or time selection feature can enable a user to switch between different fields and adjust the fields individually, e.g., enable a user to adjust a month, day, and/or year, and switch between hours, minutes, seconds, and/or pm or am individually.

A user can operate the selection feature by making contact with a region of the touch-sensitive display where the selection feature is provided. System 100 can receive the user input to determine the manner in which the displayed value is to be adjusted (220). The user input can include the user selecting and moving the object or button on the closed track of the selection feature (222). The user input can also include the user selecting a location on the closed track away from the selectable object or button (224). In other examples, the user input can include the user selecting a portion of the closed track that corresponds to a particular segment of the closed track (226).

Based on the received user input, the displayed value or number can be adjusted by system 100 (230). For example, the displayed value can be adjusted in a first manner in response to the user selecting and moving the selectable object or button along the closed track, and can be adjusted in a second manner in response to the user selecting a location on the closed track away from the current position of the selectable object or button.

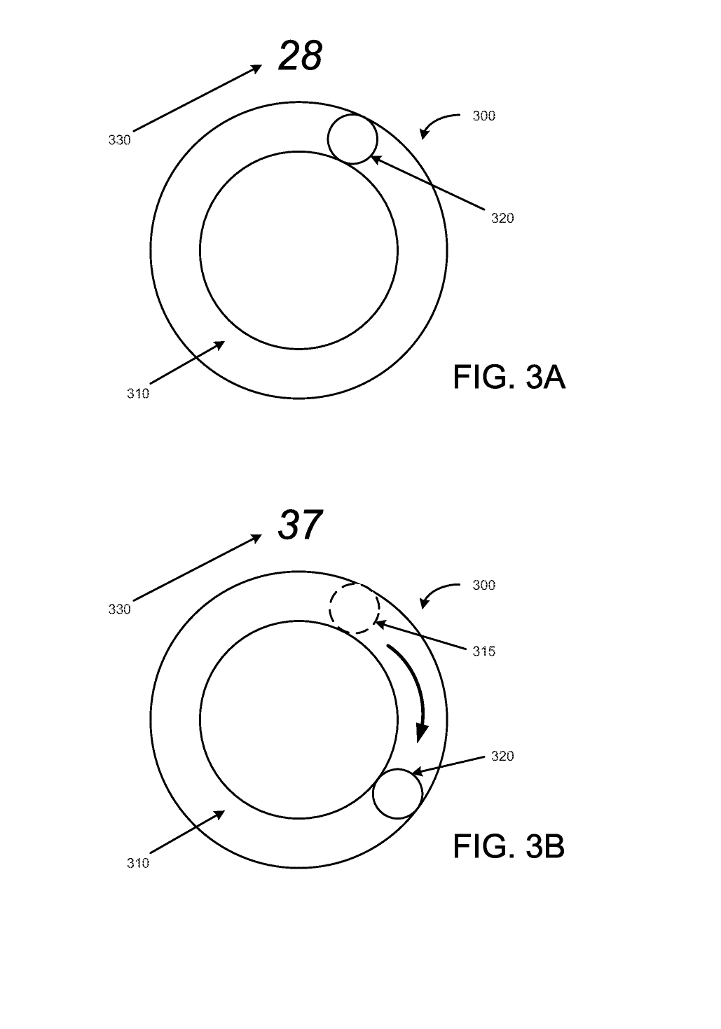

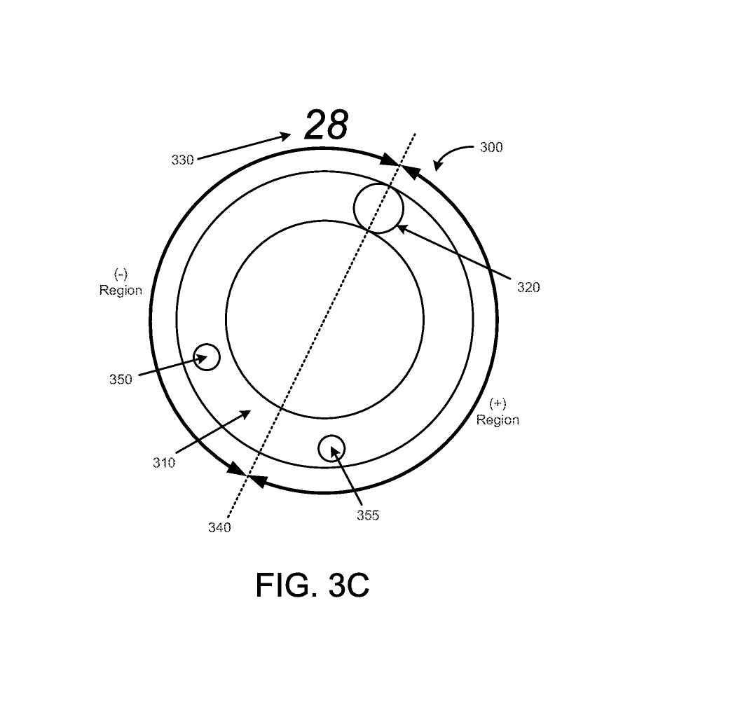

FIGS. 3A through 3C illustrate example operations of a selection feature for a computing device. The selection feature 300 can be an example of a selection feature that is provided by, for example, components described with FIGS. 1 and 2. The selection feature 300 can be displayed with or as part of an application or device functionality to enable a user to select a number, value, or option using the selection feature 300.

In FIG. 3A, the selection feature 300 is formed of two concentric circular boundaries that make up a closed track 310. In other variations, the closed track 310 can be formed of different shapes, such as an oval, an ellipse, a triangle, a square, etc. The selection feature 300 can also include a selectable object or button 320 that is moveable along and around the closed track 310. The selectable object 320 can be a graphic image, icon, shape, etc., that is distinct from the closed track 310 so that an operating user can easily distinguish between the two (e.g., the selectable object 320 can be a different color than the closed track or have a different shading texture, etc.). In the examples described in FIGS. 3A through 3C, the selectable object 320 is a circle that has a diameter that is equal to the width of the closed track 310.

As an addition or an alternative, the closed track 310 can be dynamically changed in shape, color, and/or texture in response to the direction in which the selectable object 320 is moved by the user (e.g., based on the direction of rotation). For example, moving the selectable object 320 clockwise can change the shape of the closed track 310 to be a triangular shape, whereas moving the selectable object 320 counter-clockwise can change the shape of the closed track 310 to be an elliptical shape. In another example, the selectable object 320 can also change its shape image, icon, color, and/or shape based on the direction of rotation. When the user finishes interacting with the closed track 310, the closed track 310 can remain in the shape last changed to or change back to its original shape. In some variations, the manner in which the closed track 310 and/or the selectable object 320 can be changed can be configurable by the user.

The selectable feature 300 can include a displayed value 330. The displayed value (e.g., “28”) can correspond to the number that is currently represented by the selection feature 300. As the user operates the selection feature 300 by providing touch input on a region of the touch-sensitive display that provides the selection feature 300, the displayed value 330 can dynamically be updated in a manner based on the user's input. In other examples, when the selection feature 300 is provided to enable a user to adjust more than one value, the user can tap on the area within the inner circular boundary to change which value to adjust. For example, if the user is operating an application in which a user can provide three numbers that represent a combination lock, the displayed values can be shown as “17, 00, 00,” where the underline represents the value that the user is currently adjusting with the selection feature 300. Once the user has completed adjusting the first value, the user can select a region within the inner circular boundary to change the next displayed value, so that the displayed values can be shown as “17, 32, 00,” where the user has changed the second value from “00” to “32.”

FIG. 3B illustrates an operation of the selection feature 300 when the user provides a first type of input. In FIG. 3B, the user has selected and moved the selectable object 320 from a first or previous position 315 to a second position on the closed track 310 (e.g., in the direction indicated by the arrow). As the user selects, holds, and moves the selectable object 320 in this fashion, the selection feature 300 adjusts the displayed value 330 in a first manner or mode. The selection feature 330 dynamically updates the displayed value 330 incrementally based on the speed in which the selectable object 320 is moved. In some examples, when the selectable object 320 is moved in a clockwise direction, the displayed value 330 is increased, whereas when the selectable object 320 is moved in a counter-clockwise direction, the displayed value 330 is decreased. In other variations, the clockwise direction can decrease the displayed value 330, while the counter-clockwise direction can increase the displayed value 300.

FIG. 3C illustrates the operation of the selection feature 300 when the user provides a different input. The selection feature 300 enables the user to adjust the displayed value by selecting a location (e.g., locations 350, 355) on the closed track 310 that is away from the selectable object or button 320. The feature control 110 of FIG. 1, for example, determines the current position of the selectable object 320 and divides or separates the closed track 310 into two regions, a minus (−) region and a positive (+) region. The regions can be determined based on an axis 340 that intersects the current position of the selectable object 320 and substantially splits the closed track 310 in halves. As such, the regions are dynamically determined based on the current position of the selectable object 320. When the user taps on a location that is on the closed track and away from the selectable object 320, depending on the region in which the tapped location resides, the displayed value 330 can be increased or decreased.

For example, based on the dynamically determined regions of the selectable feature 300, for the user to decrease the displayed value 330, the user can tap a location on the closed track 310 that is (i) away from the current position of the selectable object 320, (ii) counter-clockwise from the selectable object 320, and (iii) within a particular distance, on the closed track 310, from the selectable object 320 (e.g., must be within the (−) region indicated by the axis 340). If the user selects a first location 350, which is determined to be within the (−) region, the selection feature 300 adjusts the displayed value 330 in a second manner or mode. In some examples, the selection feature dynamically decreases the displayed value 330 (e.g., because the user selected the first location 350 in the (−) region) in larger amounts (as opposed to incrementally).

Depending on implementation, when the user selects the location 350, the selectable object 320 can move or jump to the location 350. The displayed value 330 can be decreased to reflect an updated value that is representative of the selectable object 320 being at the location 350 (e.g., the value can be decreased from “28” to “20.”). In addition, because the position of the selectable object 320 changed, feature control 110 can dynamically determine the (−) region and the (+) region based on the updated position of the selectable object 320.

In another example, when the user selects the location 350, the selectable object 320 can move along the closed track 310 closer towards the location 350, but not jump straight to the location 350. In this example, the displayed value 330 can decrease from “28” to “26,” where “26” reflects an updated value that is representative of the selectable object 320 being moved counter-clockwise to a different position. When the user selects the same location 350 again, the selectable object 320 can again move along the closed track 310 closer towards the location 350, and the displayed value can decrease from “26” to “24.” Another selection of the location 350 can then cause the selectable object 320 to be moved to the location 350. In this manner, the selection feature 300 enables the user to adjust a displayed value or change an option in different manners by interacting with the selection feature 300 in multiple ways.

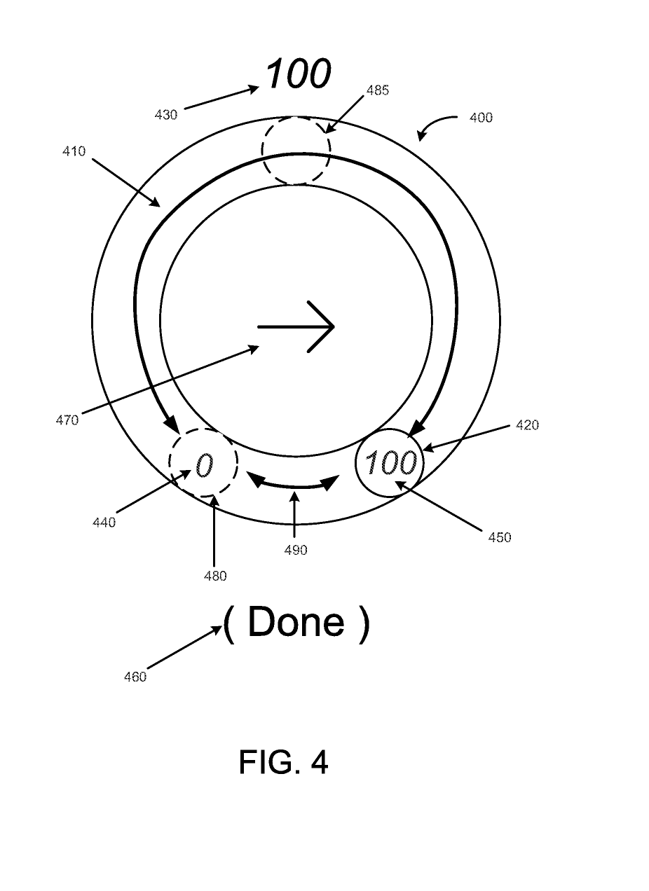

FIG. 4 illustrates an example of a selection feature for a computing device. The selection feature 400 can be an example of a selection feature that is provided by, for example, components described with FIGS. 1 and 2. The selection feature 400 can be similar to the selection feature 300 described with FIGS. 3A through 3C, but have additional or different characteristics. The selection feature 400 can be displayed with or as part of an application or device functionality to enable a user to select a number, value, or option using the selection feature 400.

The selection feature 400 includes a closed track 410, a selectable object or button 420, and a displayed value 320, similar to the selection feature 300 of FIGS. 3A through 3C. The selection feature 400 can also have a limit, such as a minimum value 440 (e.g., indicated by “0” that is positioned on the closed track 410) and a maximum value 450 (e.g., as indicated by “100” that is positioned on the closed track 410). In some examples, the minimum value 440 and the maximum value 450 do not have to be graphically displayed with the closed track 410 (e.g., not displayed with the selection feature 400 or displayed elsewhere). As a result of implementing a minimum value 440 and a maximum value 450, the selection feature 400 provides a range of values that the user can select.

In the example illustrated in FIG. 4, the selectable object 420 is currently positioned at the maximum value 450 position, and the displayed value 430 shows a “100.” Position 480 indicates the lower limit in which the selectable object 420 can be moved to. In some examples, the user can select and move the selectable object 420 on the closed track 410 only within the region indicated by the arrow within the closed track 410. The displayed value 430 can dynamically change as the user moves the selectable object 420 along such region on the closed track 410 (e.g., the displayed value 430 can change incrementally).

For example, the user can select and move the selectable object 420 to position 485, which can represent the value “50,” but cannot select and move the selectable object 420 to the voided region 490. The user may, however, tap on locations within the region indicated by the arrow within the closed track 410 to cause the selectable object 420 to move or jump straight to the position of the tapped location and to change the displayed value 430 to an updated value that is representative of the selectable object 420 being to the tapped location. In another example, if the user taps on a location that is within the voided region 490, the feature control 110 of FIG. 1, for example, can determine whether the tapped location is closer to the minimum position 480 or the maximum position 450 and cause the selectable object 420 to move or jump straight to one of the positions.

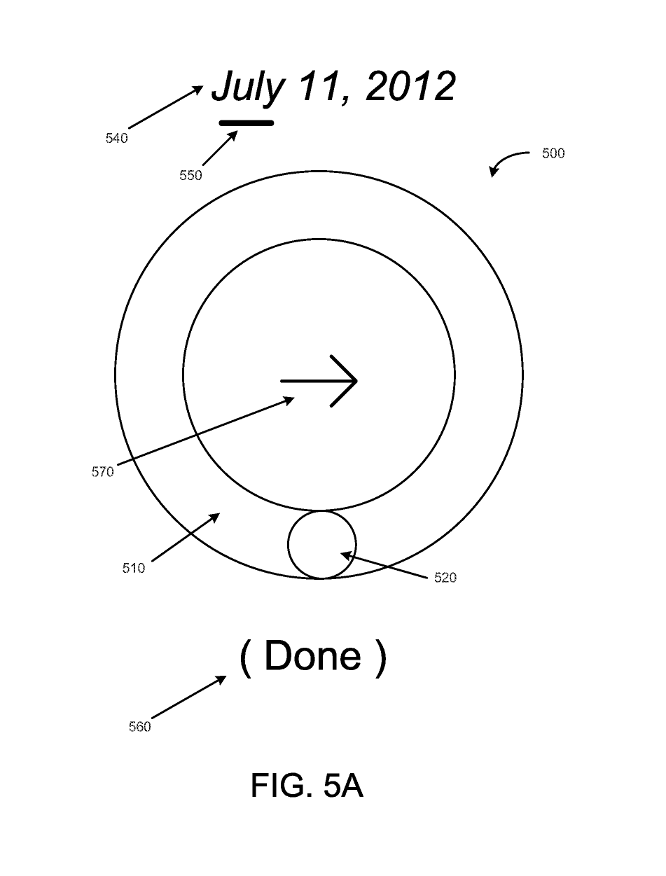

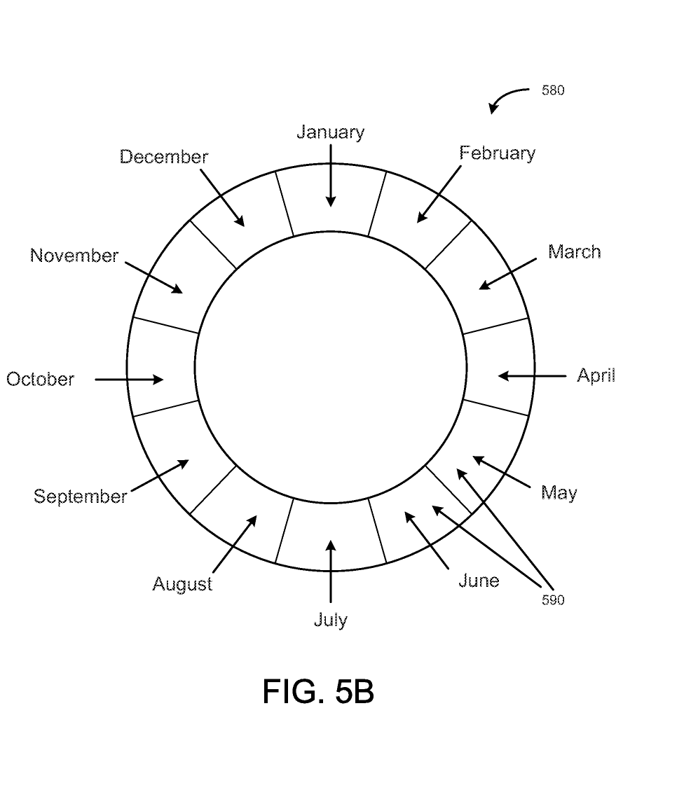

FIGS. 5A and 5B illustrate an example of a selection feature for a computing device. The selection feature 500 can be an example of a selection feature that is provided by, for example, components described with FIGS. 1 and 2. The selection feature 500 can be displayed with or as part of an application or device functionality to enable a user to change or set a date using the selection feature 500. For example, the selection feature 500 can be provided with a calendar application or date settings functionality for a computing device.

The selection feature 500 includes a closed track 510, a selectable object or button 520, and displayed values 540. The selection feature 500 can enable a user to change or set a date by individually adjusting a selected value (as indicated by the underline 550), such as a month, date, and a year. In the example described in FIG. 5A, the underline 550 is positioned underneath the month field of the displayed values 540 (e.g., the user is currently operating the selection feature 500 to adjust the month). Because the allowable options for the particular field (e.g., the month field) is limited to particular number (e.g., only twelve options, one for each month), the selection feature 500 is segmented into different regions or segments.

For example, illustration 580 of FIG. 5B represents the segmentation of the closed track 510 of the selection feature 500. The illustration 580 corresponds to the segmentation of the closed track 510 when the user is operating the selection feature 500 to adjust the month field of the date. In this case, the closed track 510 is segmented into twelve regions or segments 590, with each segment 590 corresponding to a month. The user can select and move the selectable object 520 to a position to a position of one of the segments 590 in order to dynamically change the month field to the corresponding month. If, for example, the selectable object 520 was positioned at the position corresponding to “January,” the user can select and move the selectable object 520 to the position for “July” to cause the displayed value 540 to incrementally adjust (e.g., slowly or quickly) the month field from “January” to “February” to “March, etc., until the month field changes to “July.”

The user can also tap on a location on the closed track 510 that is at a distance away from the selectable object 520 to cause the selectable object 520 to move or jump to the position of the tapped location. The feature control 110 of FIG. 1, for example, can determine which segment 590 the tapped location resides in and cause the month field to be changed automatically from “January” to “July.” Once the user has completed changing the month, the user can select a region 570 within the inner circular boundary of the closed track 510 in order to adjust a different field of the date. For example, if the user taps on the region 570 (e.g., which can include a displayed arrow to indicate the next field), the underline 550 can move to the “11,” which is the current day field set for the date.

The feature control 110 can determine that there are thirty one days in the month of July, which has been selected by the user, and can segment the closed track 510 into thirty one regions or segments (e.g., compared to twenty eight, twenty nine or thirty days for other months). The user can then manipulate the selection feature 500 to select the appropriate day. Similarly, the user can then tap on the region 570 to adjust the year field of the date. Once the underline 550 is moved to the “2012” or year field of the displayed values 540, the feature control 110 can enable the user to adjust the year using the selection feature 500 as a basic or generic selection feature as described in FIGS. 3A through 3C or as a selection feature having a minimum and/or maximum value as described with FIG. 4. In some implementations, instead of selecting the region 570 to change fields, the user can tap on a field of the displayed values 540 to select which field to adjust with the selection feature 550.

If the user has completed or has selected the appropriate date, the user can select a “done” or “confirmation” feature 560 to cause the selection feature 500 to be dismissed or removed from the display of the computing device. In some examples, the selection feature 500 can also be displayed with a “cancel” feature to enable the user to quit or cancel out of the selection feature 500 without accepting any changes.

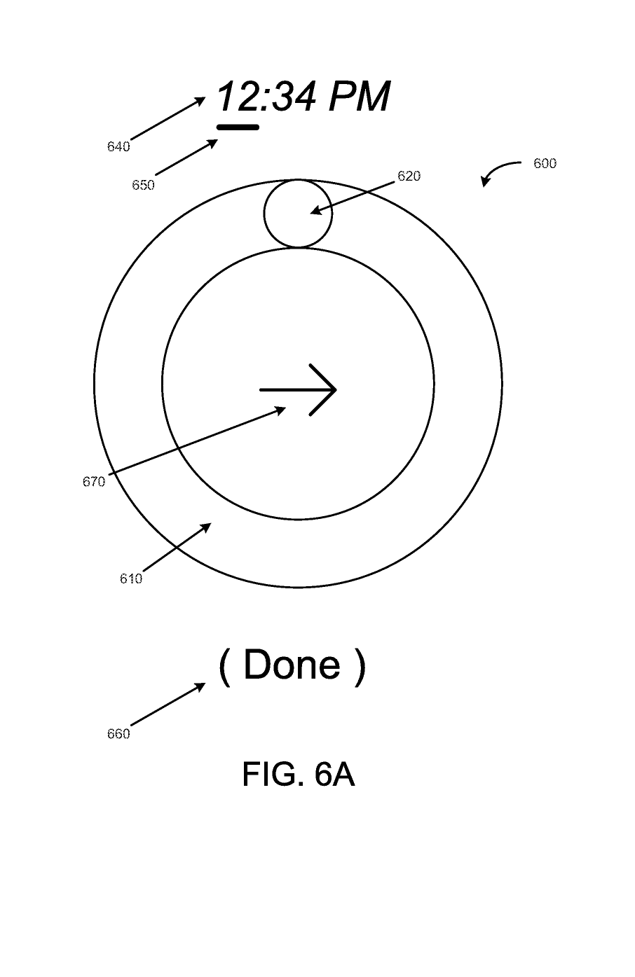

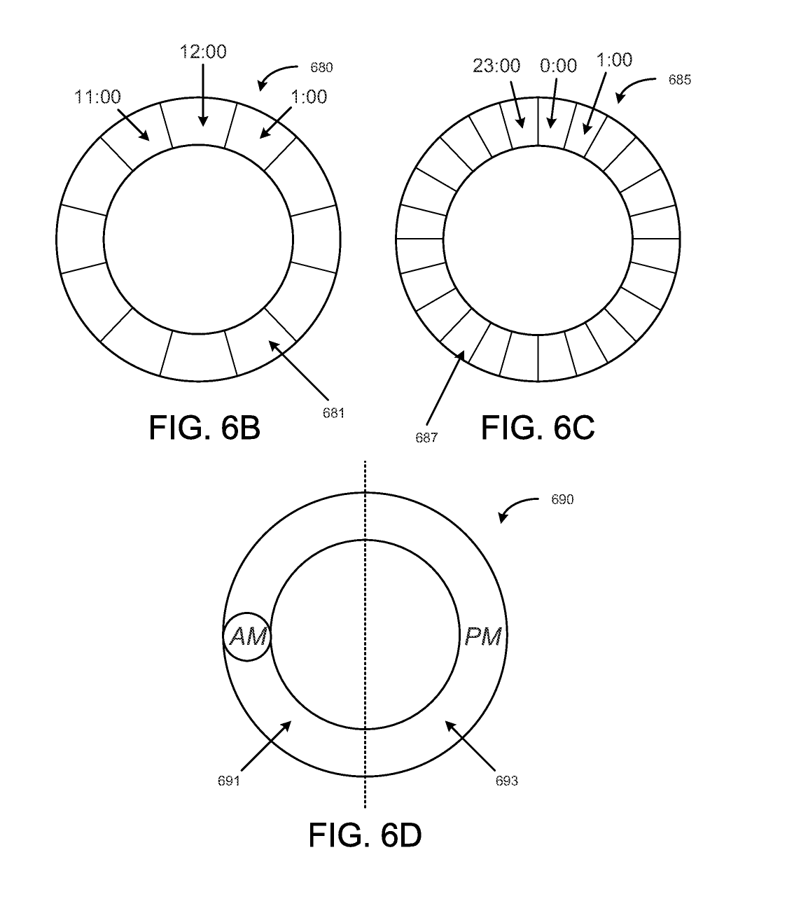

FIGS. 6A through 6D illustrate an example of a selection feature for a computing device. The selection feature 600 can be an example of a selection feature that is provided by, for example, components described with FIGS. 1 and 2. The selection feature 600 can be displayed with or as part of an application or device functionality to enable a user to change or set a time using the selection feature 500. For example, the selection feature 600 can be provided with a clock application, a calendar application, or date settings functionality for a computing device.

The selection feature 600 includes a closed track 610, a selectable object or button 620, and displayed values 640. The selection feature 600 can enable a user to change or set a time by individually adjusting a selected value (as indicated by the underline 650), such as an hour, a minute, a second, and am or pm. In the example described in FIG. 6A, the underline 650 is positioned underneath the hour field of the displayed values 640 (e.g., the user is currently operating the selection feature 600 to adjust the hour). Similar to the selection feature of FIG. 5A, the allowable options for the hour field is limited to (i) one to twelve for a twelve hour setting (e.g., when the clock application, calendar application, or date setting functionality is configured by the user to be in the twelve hour setting), or (ii) zero to twenty three for a twenty four hour or military time setting. The selection feature 600 can be segmented into different regions or segments according to the appropriate time or clock setting.

For example, illustration 680 of FIG. 6B represents the segmentation of the closed track 610 of the selection feature 600. The illustration 680 corresponds to the segmentation of the closed track 610 when the user is operating the selection feature 600 to adjust the hour field in a twelve hour format. The closed track 610 is then segmented into twelve regions or segments 681, with each segment 681 corresponding to a particular hour. On the other hand, illustration 685 of FIG. 6C represents the segmentation of the closed track 610 when the user is operating the selection feature 600 to adjust the hour field in a twenty four hour or military format. The closed track 610 can be segmented into twenty four regions or segments 687.

The user can select and move the selectable object 620 to a position to a position of one of the segments 681, or 687 depending on the type of hour configuration in order to dynamically change the hour field to the corresponding hour. The user can manipulate the selection feature 600 of FIG. 6A in the manner discussed with FIGS. 1 through 5B in order to select or adjust the hour field (e.g., select and move the selectable object 620 or select a location away from the selectable object 620 on the closed track 610). If, for example, the selectable object 620 was positioned at the position corresponding to “9,” the user can select and move the selectable object 620 to the position for “12” (e.g., by moving clockwise or counter-clockwise) to cause the hour field of the displayed value 640 to be incrementally adjusted (e.g., slowly or quickly based on the speed of the user's input).

Similarly, the user can tap on a location on the closed track 610 that is at a distance away from the selectable object 620 to cause the selectable object 620 to move or jump to the position of the tapped location. The feature control 110 of FIG. 1, for example, can determine which segment 681, 687 (depending on whether the clock configuration is a twelve hour or twenty four hour format) the tapped location resides in and cause the hour field to be changed respectively. Once the user has completed changing the hour, the user can select a region 670 within the inner circular boundary of the closed track 610 in order to adjust a different field of the time. If, for example, the user taps on the region 670, the underline 550 can move to the minute field and the user can operate the selection feature to select the appropriate minute. Similarly, the feature control 110 can segment the closed track 610 into sixty segments, one for each minute of an hour. In other implementations, when the user chooses to adjust the minute field of the displayed values 640, the selection feature 600 can be displayed as having a minimum value (e.g., zero minutes) and a maximum value (e.g., sixty minutes), such as described with FIG. 4, to enable the user to select the appropriate minute of the time.

When the user chooses to adjust the am/pm of the time in the twelve hour format, the selection feature 600 is adjusted to be a toggle between “AM” or “PM,” as illustrated in FIG. 6D. The user can select and move the selectable object 620 to either the “AM” or “PM” graphic that is provided within the closed track 610 or to any of the corresponding region 691, 693 within the closed track 610. The user can also tap on a location within the region 691, 693 to cause the appropriate “AM” or “PM” to be selected.

Again, if the user has completed or has selected the appropriate time, the user can select a “done” or “confirmation” feature 660 to cause the selection feature 600 to be dismissed or removed from the display of the computing device (e.g., close the pop-up window in some examples). In other examples, the selection feature 600 (and/or the pop-up window) can also be displayed with a “cancel” feature to enable the user to quit or cancel out of the selection feature 600 without accepting any changes.

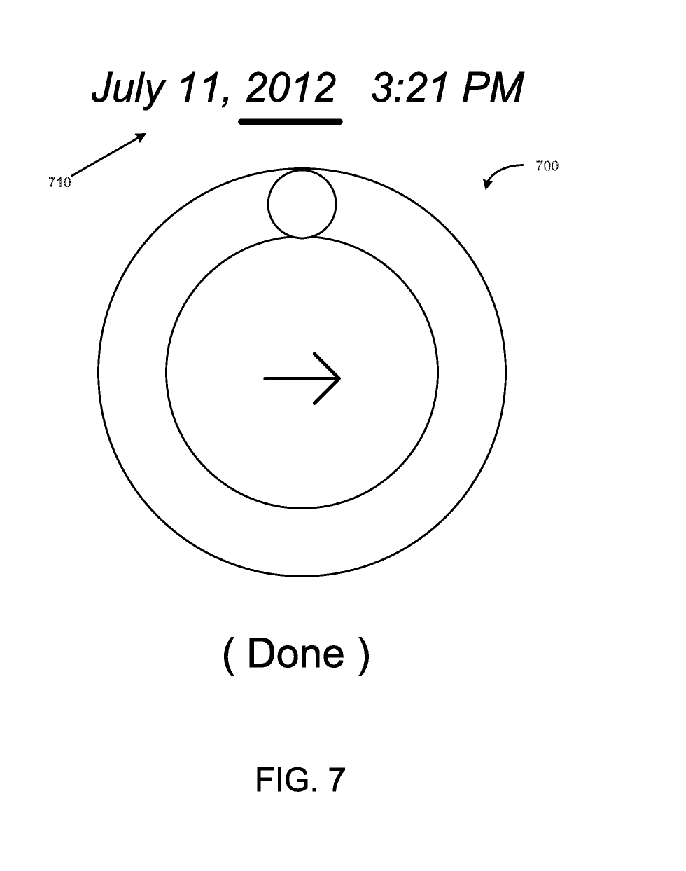

FIG. 7 illustrates an example of a selection feature for a computing device. FIG. 7 illustrates a selection feature 700 that can be provided by, for example, components described with FIGS. 1 and 2. The selection feature 700 is similar to the selection features 500 and 600 of FIGS. 5A through 6D, but includes both a date and a time as the displayed values 710. The user can manipulate the selection feature 700 to adjust each of the month, day, year, hour, minute, and am/pm using the selection feature 700. Depending on implementation, the user can adjust each value in a respective fashion as described with FIGS. 1 through 6D.

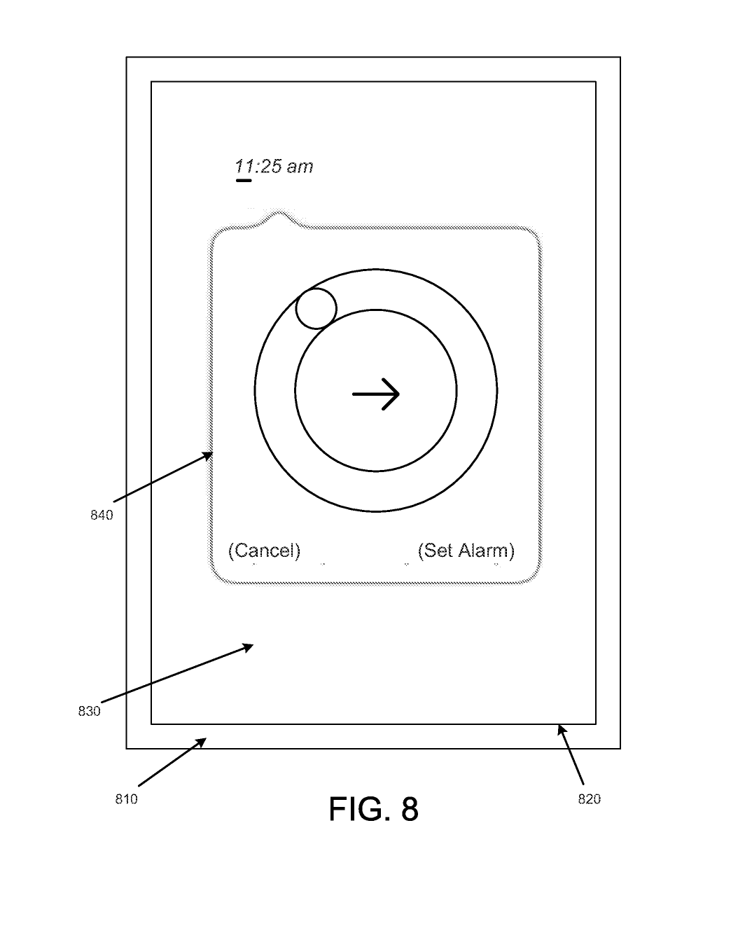

FIG. 8 illustrates an example of a selection feature for a computing device displayed with an application. The selection feature described in FIG. 8 can be provided by, for example, components described with FIGS. 1 and 2. In FIG. 8, the selection feature is displayed with or as part of an application or device functionality to enable a user to select a number, value, or option using the selection feature.

FIG. 8 illustrates a computing device 810 having a display screen 820. In one example, the display screen 820 can be a touch-sensitive display screen. In other implementations, the computing device 810 can include one or more sensors, such as one or more image capturing components, one or more microphones, one or more proximity sensors, one or more depth sensors, one or more pressure sensors, one or more touch sensors, and/or a combination of the described sensors to detect a user's finger or object motion relative to the display screen 820. The one or more sensors can, for example, detect the position of the user's finger or object, the movement of the user's finger or object, and the velocity in which the user's finger or object is moving, relative to the selection feature that is displayed on the display screen 820.

A user can operate the computing device 810 to run an application having an application user interface 830. The application, for example, can be a clock application in which the user can adjust the current time or set an alarm, etc. In the example described, the user has selected a feature or option on the application user interface 830 to indicate that the user wants to change or adjust an alarm. In response to such a selection, a pop-up feature 840 can be provided to overlay the application user interface 830. The pop-up window 840 can be positioned adjacent to or just below the displayed value(s) (e.g., “11:25 am”). The user can interact with the selection feature provided in the pop-up window 840 (such as described with FIGS. 1 through 7) in order to adjust the time for the alarm. The pop-up window 840 can also include a “cancel” selectable feature to cancel the changes the user has made and to void the operation, and/or a “set,” “done,” or “confirm” (e.g., “set alarm”) selectable feature to accept the user's changes.

Hardware Diagram

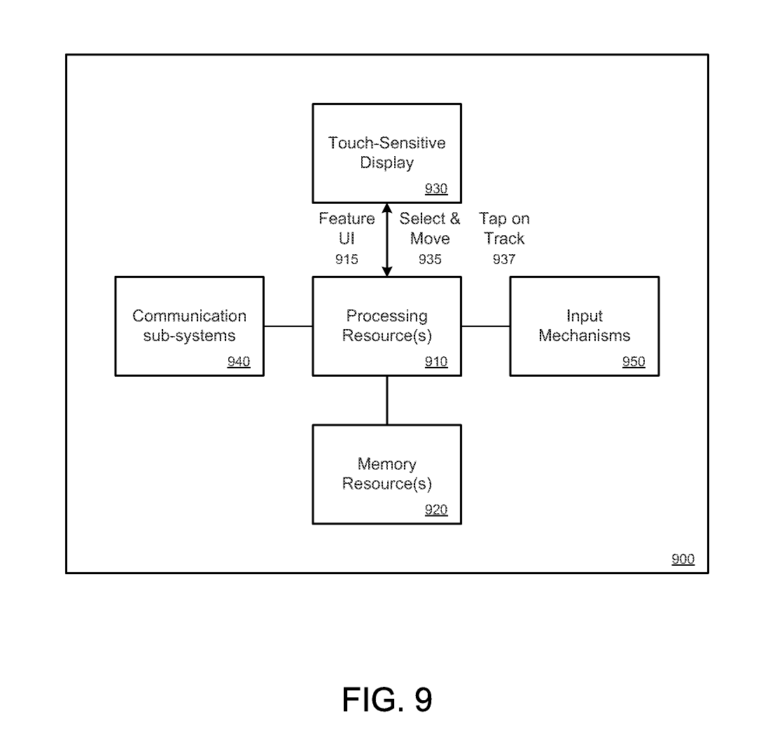

FIG. 9 is a block diagram that illustrates a computing device upon which examples described herein may be implemented. In one example, a computing device 900 may correspond to a mobile computing device, such as a cellular device that is capable of telephony, messaging, and data services. Examples of such devices include smartphones, handsets or tablet devices for cellular carriers, a desktop computer, a notebook, an all-in-one computer, or any additional computing device. Computing device 900 includes a processor (or one or more processors) 910, memory resources 920, a touch-sensitive display device 930, one or more communication sub-systems 940 (including wireless communication sub-systems, such as a radio component, Bluetooth component, wireless network interface component, etc.), and input mechanisms 950 (e.g., an input mechanism can include or be part of the touch-sensitive display device). In one example, at least one of the communication sub-systems 940 sends and receives cellular data over data channels and voice channels.

As an addition or alternative, the input mechanisms 950 can include one or more sensors, such as one or more image capturing components, one or more microphones, one or more proximity sensors, one or more depth sensors, one or more pressure sensors, one or more touch sensors, and/or a combination of the described sensors, to detect a user's finger or object motion relative to the display device (e.g., when the display device 930 is not a touch-sensitive display). The one or more sensors can, for example, detect the position of the user's finger or object, the movement of the user's finger or object, and the velocity in which the user's finger or object is moving, relative to the selection feature 915 that is displayed on the display device.

The processor 910 is configured with software and/or other logic to perform one or more processes, steps and other functions described with implementations, such as described by FIGS. 1 through 8, and elsewhere in the application. Processor 910 is configured, with instructions and data stored in the memory resources 920, to provide a selection feature and enable a user to operate the selection feature, as described in FIGS. 1 through 8. For example, instructions for providing the selection feature 915 on the touch-sensitive display 930 and for enabling the user to operate the selection feature 915 can be stored in the memory resources 920 of the computing device 900. In one implementation, the processor 910 can receive a select and move input 935, which corresponds to the user selecting and moving the selectable object or button along the closed track of the selection feature 915, and a tap on track input 937, which corresponds to the user selecting a location on the closed track away from the selectable object or button. The processor 910 can adjust a value based on the input. The communication sub-systems 940 can enable the computing device 900 to communicate with other servers and computing devices, for example, over a network (e.g., wirelessly or using a wireline).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method of operating a computing device, the method being performed by one or more processors and comprising:
providing, on a display of the computing device, a selection feature to enable a user to adjust a displayed value, the selection feature including a closed track and a selectable button that is moveable along the closed track, wherein the closed track is formed of two concentric circular boundaries;
receiving a user input from one or more sensors of the computing device that detect an object or a finger on a region of the display that provides the selection feature, wherein the selection feature (i) adjusts the displayed value in a first manner in response to the user selecting and moving the selectable button along the closed track, and (ii) adjusts the displayed value in a second manner in response to the user selecting a location on the closed track away from the selectable button; and
adjusting the displayed value based on the user input.

2. The method of claim 1, wherein the one or more sensors includes at least one of a touch-sensitive display, an image capturing component, a microphone, a proximity sensor, a depth sensor, a pressure sensor, or a touch sensor.

3. The method of claim 1, wherein the selection feature (i) increases the displayed value in response to the user selecting and moving the selectable button along the closed track in a clockwise direction, and (ii) decreases the displayed value in response to the user selecting and moving the selectable button along the closed track in a counter-clockwise direction.

4. The method of claim 1, wherein the selection feature (i) increases the displayed value in response to the user selecting a location, on the closed track, that is clockwise from the selectable button and within a predetermined distance from the selectable button, and (ii) decreases the displayed value in response to the user selecting a location, on the closed track, that is counter-clockwise from the selectable button and within the predetermined distance from the selectable button.

5. The method of claim 1, wherein the selection feature includes a minimum value displayed on the closed track and a maximum value displayed on the closed track, and wherein adjusting the displayed value includes adjusting the displayed value within the minimum value and the maximum value.

6. A computing device comprising:
a display;
one or more memory resources; and
one or more processors coupled to the display and the one or more memory resources, the one or more processors to:
operate an application stored on the one or more memory resources, the application enabling a user to configure a time element;
provide, on the display, a selection feature to enable the user to adjust the time element, the selection feature including a closed track and a selectable button that is moveable along the closed track, wherein the closed track is formed of two concentric circular boundaries;
receive a user input from one or more sensors of the computing device that detect an object or a finger on a region of the display that provides the selection feature, wherein the selection feature (i) adjusts the time element in a first manner in response to the user selecting and moving the selectable button along the closed track, and (ii) adjusts the time element in a second manner in response to the user selecting a location on the closed track away from the selectable button; and
adjust the time element based on the user input.

7. The computing device of claim 6, wherein the selection feature includes a selectable option to enable the user to change which of the time element is to be adjusted, and wherein the time element includes at least one of a month, a day, or a year.

8. The computing device of claim 7, wherein the processor sections the closed track into a plurality of segments based on the indicated month or day that is to be adjusted.

9. The computing device of claim 8, wherein the selection feature indicates that the month is to be adjusted, the processor sections the closed track into twelve segments, and wherein when the selection feature indicates that the day is to be adjusted, the processor sections the closed track into the plurality of segments based on the month that has been previously selected.

10. The computing device of claim 8, wherein the selection feature (i) increases the indicated month, day, or year in response to the user selecting and moving the selectable button along the closed track in a clockwise direction, and (ii) decreases the indicated month, day, or year in response to the user selecting and moving the selectable button along the closed track in a counter-clockwise direction.

11. The computing device of claim 8, wherein when the selection feature adjusts the indicated month or year in response to the user selecting a location, on the closed track, corresponding to one of the plurality of segments.

12. A non-transitory computer-readable medium storing instructions that, when executed by one or more processors, causes the one or more processors to perform steps comprising:
providing, on a touch-sensitive display of a computing device, a pop-up feature that is displayed with an application, the pop-up feature including (i) a selection feature to enable a user to adjust a displayed value, the selection feature including a closed track and a selectable object that is moveable along the closed track, and (ii) a completion feature, wherein the closed track is formed of two concentric circular boundaries;
receiving a user input by detecting contact of a finger of the user on a region of the touch-sensitive display that provides the selection feature, wherein the selection feature (i) adjusts the displayed value in a first manner in response to the user selecting and moving the selectable object along the closed track, and (ii) adjusts the displayed value in a second manner in response to the user selecting a location on the closed track away from the selectable object;
adjusting the displayed value based on the user input; and
removing, from being displayed on the touch-sensitive display, the pop-up feature in response to a user input selecting the completion feature.

13. The non-transitory computer-readable medium of claim 12, wherein the selection feature includes a minimum value displayed on the closed track and a maximum value displayed on the closed track, and wherein adjusting the displayed value includes adjusting the displayed value within the minimum value and the maximum value.

14. A method of operating a computing device, the method being performed by one or more processors and comprising:
providing, on a display of the computing device, a selection feature to enable a user to adjust a displayed value, the selection feature including a closed track and a selectable button that is moveable along the closed track, wherein the selection feature includes a minimum value displayed on the closed track and a maximum value displayed on the closed track, and wherein adjusting the displayed value includes adjusting the displayed value within the minimum value and the maximum value;
receiving a user input from one or more sensors of the computing device that detect an object or a finger on a region of the display that provides the selection feature, wherein the selection feature (i) adjusts the displayed value in a first manner in response to the user selecting and moving the selectable button along the closed track, and (ii) adjusts the displayed value in a second manner in response to the user selecting a location on the closed track away from the selectable button; and
adjusting the displayed value based on the user input.

15. The method of claim 14, wherein the one or more sensors includes at least one of a touch-sensitive display, an image capturing component, a microphone, a proximity sensor, a depth sensor, a pressure sensor, or a touch sensor.
